(19) United States
(12) Patent Application Publication
(10) Pub. No.: US 2014/0116536 A1
(43) Pub. Date: May 1, 2014

(54) LOCKING ENCLOSURE FOR A VALVE, PORT, OR OTHER FIXTURE

(71) Applicant: BAKER COMMODITIES, INC., Vernon, CA (US)

(72) Inventor: Domingo G. Resendiz, Norwalk, CA (US)

(73) Assignee: BAKER COMMODITIES, INC., Vernon, CA (US)

(21) Appl. No.: 13/662,115

(22) Filed: Oct. 26, 2012

(51) Int. Cl. F16P 1/00

(52) U.S. Cl. 137/377

(57) ABSTRACT

A lockable housing for a valve, tap, port, or other fixture is provided. The housing has a hinged clam shell design, with a protective shroud for a shackleless lock. A fixture can be encased within the housing and secured using the shackleless lock.

### FIELD OF THE INVENTION

The invention relates to anti-theft and anti-tamper devices for protecting valves, taps, ports, and other fixtures.

### BACKGROUND OF THE INVENTION

Valves, taps and ports, and other fixtures are used in conjunction with storage tanks, plumbing, and other fluid flow channels in a number of industries. For example, the oil and gas and chemical industries employ various valves and ports on storage tanks and pipes, wellhead “Christmas trees,” and other exterior fixtures, which are vulnerable to unauthorized access and vandalism. In restaurants and food manufacturing plants, it is common for used cooking oil to be routed from fryers through one or more pipes to a collection port accessible from the exterior of the building. By connecting a vacuum hose to the port, the spent oil can be pumped to a tanker truck and transported to a processing plant, where it can be converted into a number of products, such as animal feed, tallow, and “yellow grease,” a key ingredient in biodiesel fuels. Used cooking oil is a valuable commodity, and it attracts thieves. By some accounts, each year upwards of 50% of restaurant cooking oil is lost to thieves.

Padlocks and chains, covered guards, and numerous other devices have been employed in an effort to secure the fixtures, with limited success. U.S. Pat. No. 4, 538,434 describes a security housing for an oil tank storage valve comprising a pair of hinged clamshell structures that are also pivotally hinged to an adjacent storage tank. When closed, the structure surrounds the valve, yet swings away from the valve to allow access thereto. The structure employs a simple padlock, which is vulnerable to being cut with bolt cutters. U.S. Pat. Nos. 6,378,719 and 7,478,646 describe similar devices. U.S. Pat. No. 7,562,546 describes a locking system comprising a cylindrical padlock, a lock securing member attached thereto, a padlock guard, a hasp plate, and one or more guards. U.S. Pat. No. 6,206,033 describes a valve safety lockout device to “tamper-proof” a control valve. A similar device is described in U.S. Pat. No. 4,300,373. Although many inventors have attempted to design a secure housing for exterior plumbing fixtures, a need still exists for a more robust anti-theft and anti-tamper device.

### SUMMARY OF THE INVENTION

The invention provides a lockable housing for a valve, tap, port, or other fixture. The housing has a hinged clamshell design, with a protective shroud for a shackleless lock. A fixture can be encased within the housing and secured using the shackleless lock. In one embodiment, the housing has a first enclosure portion, bounded at one end by a first end wall and bounded at an opposite end by a first collar portion; a first tab and a first flange portion extending from the first enclosure portion; a second enclosure portion, bounded at one end by a second end wall and bounded at an opposite end by a second collar portion; a second tab and a second flange portion extending from the second enclosure portion; and a hinged joint linking the first enclosure portion to the second enclosure portion. When the first enclosure portion and the second enclosure portion are brought together in a closed configuration, (a) the first and second end walls are brought together, (b) the first and second enclosure portions form a cavity large enough to encase the fixture, (c) the first and second tabs are brought together, (d) the first and second flange portions are brought together and form a shroud adapted to protect a “shackleless” lock, and (e) the first and second collar portions form a collar. The collar has an inner diameter smaller than a portion of the fixture and thereby secures the housing from being removed from the fixture.

### BRIEF DESCRIPTION OF THE DRAWINGS

Various features and embodiments of the invention will be more readily understood when considered in light of the accompanying drawings, wherein:

FIG. 1 is a perspective view of one embodiment of the invention, in an open configuration;

FIG. 2 is a perspective view of the embodiment shown in FIG. 1, partially installed around a fixture;

FIG. 3 is a is a perspective view of the embodiment shown in FIG. 1, in a closed configuration;

FIG. 4 is a perspective view of one embodiment of a shackleless lock usable with various embodiments of the invention; and

FIG. 5 is another perspective view of the shackleless lock shown in FIG. 4;

FIG. 6 is a is a perspective proximal view of the embodiment shown in FIG. 1, in a closed configuration and with a shackleless lock seated in place; and

FIG. 7 is a perspective distal view of the embodiment shown in FIG. 1, in a closed configuration and with a shackleless lock seated in place.

### DETAILED DESCRIPTION OF THE INVENTION

In one aspect, the invention can be described in terms of an overall clam-shell design. Thus, a lockable housing for a fixture is provided and comprises a hinged, clam-shell enclosure, adapted to be moved from an open to a closed configuration; a collar at one end of the enclosure; a wall an at opposite end of the enclosure; and a hasp secured to or integral with the enclosure, adapted to hold a shackleless lock; wherein, the enclosure can be placed around a fixture and then closed; a shackleless lock can be secured to the hasp and locked in place, thereby holding the enclosure in the closed configuration; and the collar is adapted to prevent the enclosure from being removed from the fixture while the enclosure is in the closed configuration.

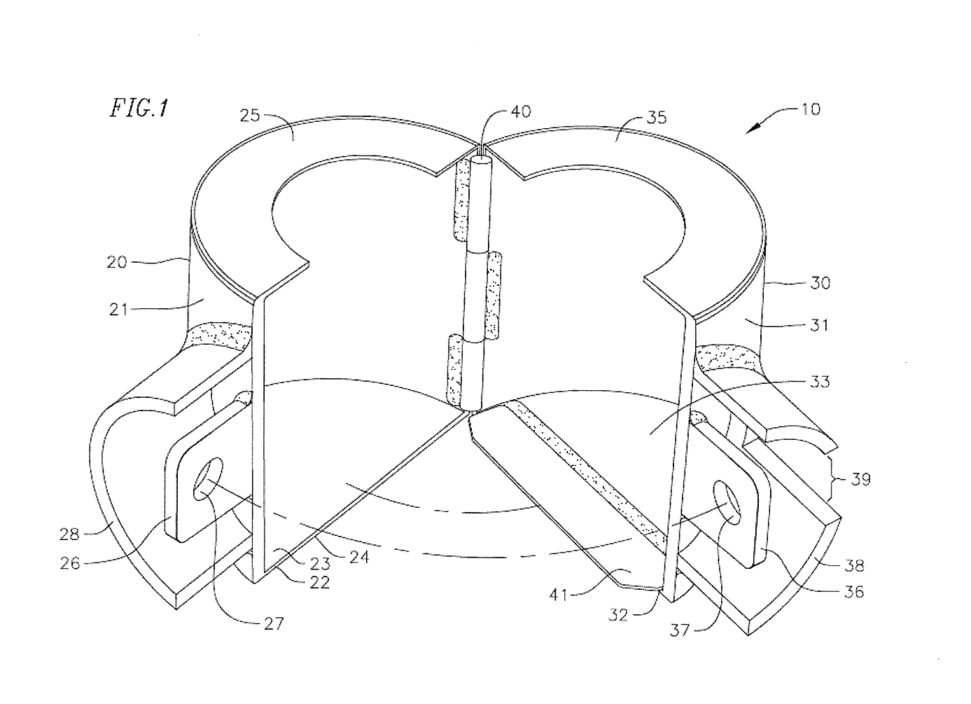

One embodiment of the invention is shown in FIGS. 1-5. A generally cylindrical, lockable housing 10 includes semicylindrical first and second enclosure portions 20, 30 linked together by a hinged joint 40. The first enclosure portion 20 includes a curved sidewall 21 bounded at one end by a first end wall 22 that has an inner surface 23 and an outer surface 24, and bounded at an opposite end by a first collar portion 25. A first tab 26 extends outwardly from the first enclosure portion 20 and has a hole 27 extending there through. A semicircular first flange 28 also extends outwardly from the first enclosure portion 20, and the first tab 26 is located in or adjacent to the semicircular space defined by the first flange.

Similarly, the second enclosure portion 30 includes a curved sidewall 31 bounded at one end by a second end wall 32 that has an inner surface 33 and an outer surface 34, and bounded at an opposite end by a second collar portion 35. A second tab 36 extends outwardly from the second enclosure portion 30 and has a hole 37 extending there through. A semicircular second flange 38 also extends outwardly from the second enclosure portion 30, and the second tab 36 is located in or adjacent to the semicircular space defined by the second flange. The second flange 38 is interrupted by a small gap 39, which provides access for a key, as described below. A lip 41 extends from the inner surface 33 of the second end wall 32 and is substantially parallel to the second end wall. When the housing is closed, the lip will overlap with a portion of the inner surface 33 of the first end wall 22.

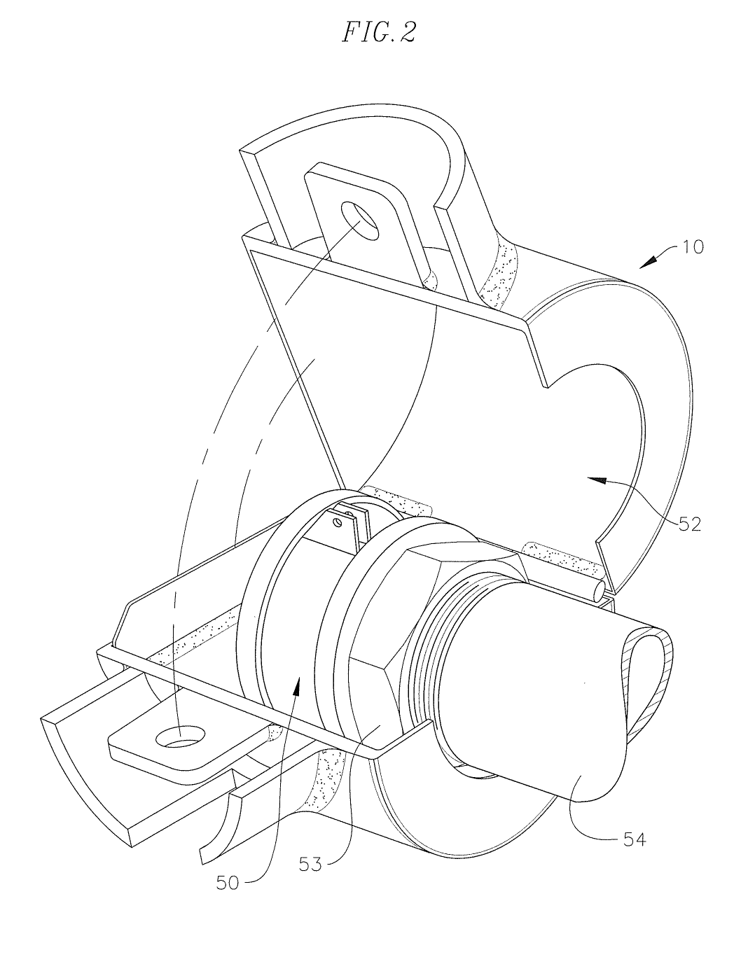

In FIG. 2, the lockable housing 10 is depicted partially placed around a fixture 50—in this case a quick connect/disconnect coupling—which is attached to the proximal end of a pipe 54. The distal end (not shown) of the pipe 54 extends into the interior of a building. This sort of fixture is often found on the exterior of a restaurant to facilitate pumping and removal of used cooking oil from one or more fryers inside the restaurant. The fixture includes a nut 53.

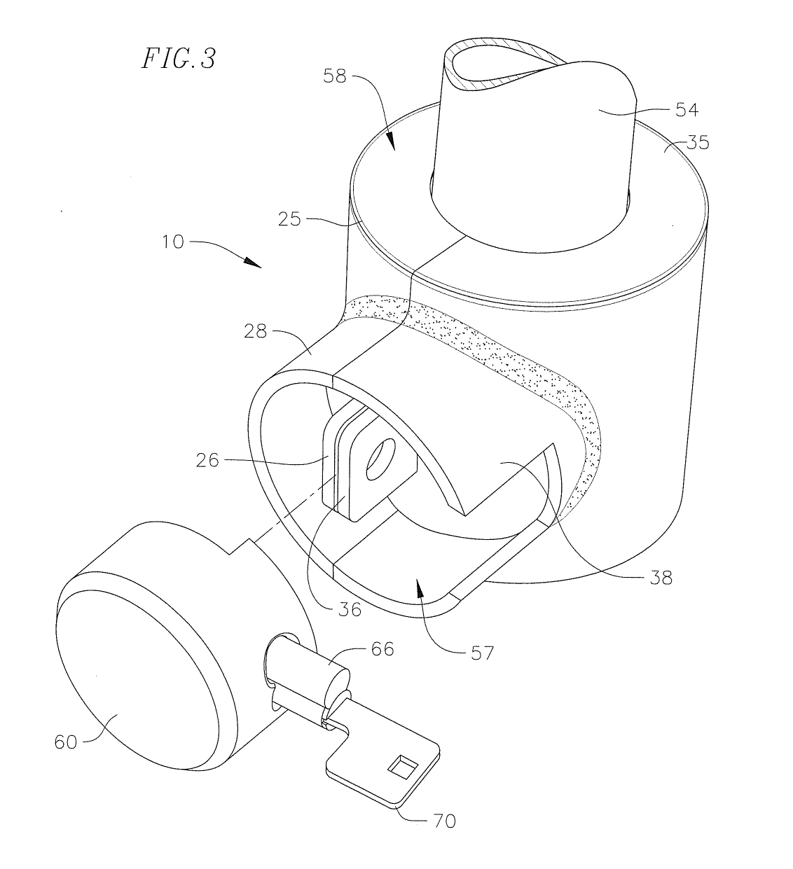

In FIG. 3, the fixture is completely encased by the housing 10, as the two halves of the housing have been brought together with the hinged joint 40. In this closed configuration, (a) the first and second end walls 22, 32 are brought together, (b) the first and second enclosure portions 20, 30 form a cavity 52 large enough to encase the fixture (see FIG. 2), (c) the first and second tabs 26, 36 are brought together, (d) the first and second flanges 28, 38 are brought together and form a shroud 56 adapted to protect a lock 60, and (e) the first and second collar portions 25, 35 form an annular collar 58 that secures the housing from being removed from the fixture. By “brought together” is meant the two pieces touch or nearly touch each other. For example, the inner edges of the first and second end walls may touch; the inner faces of the first and second tabs may touch, etc.

The inner diameter of the collar 58 is selected to be large enough to fit around the outer diameter of the pipe 54, preferably with as small a gap as possible between the collar and the pipe. A snug fit prevents the housing from rattling on the pipe when installed. In addition, because the inner diameter of the annular collar is smaller than the outer perimeter of the nut 53, the housing cannot be pulled off the fixture.

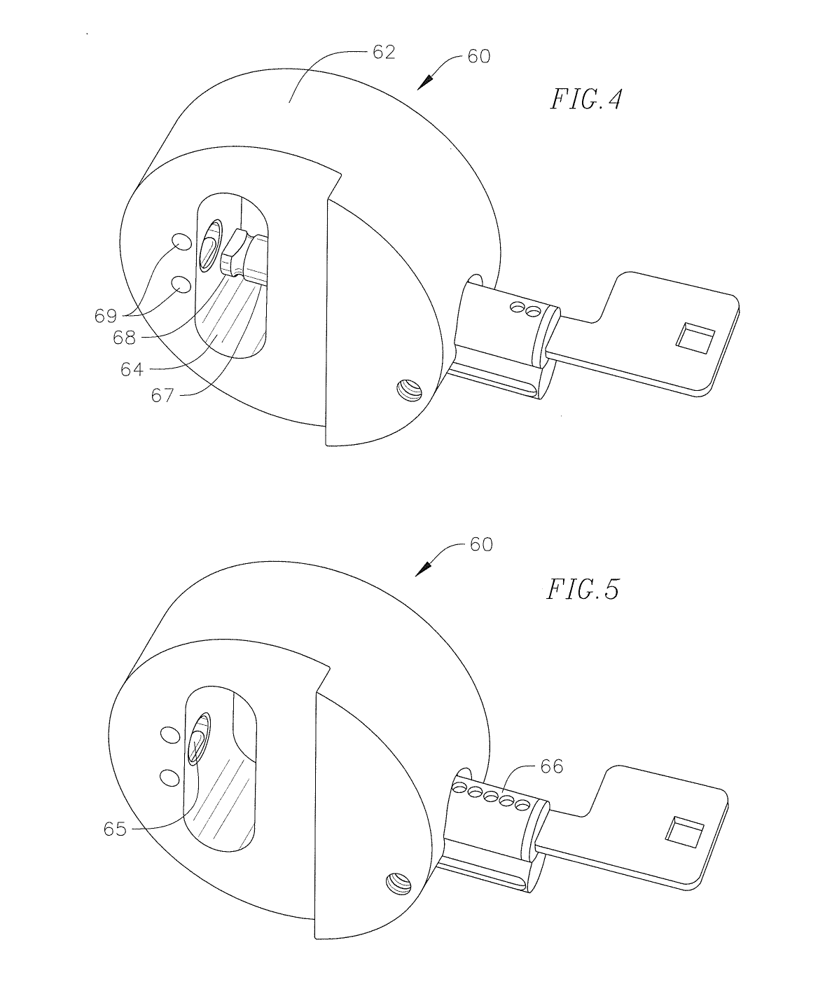

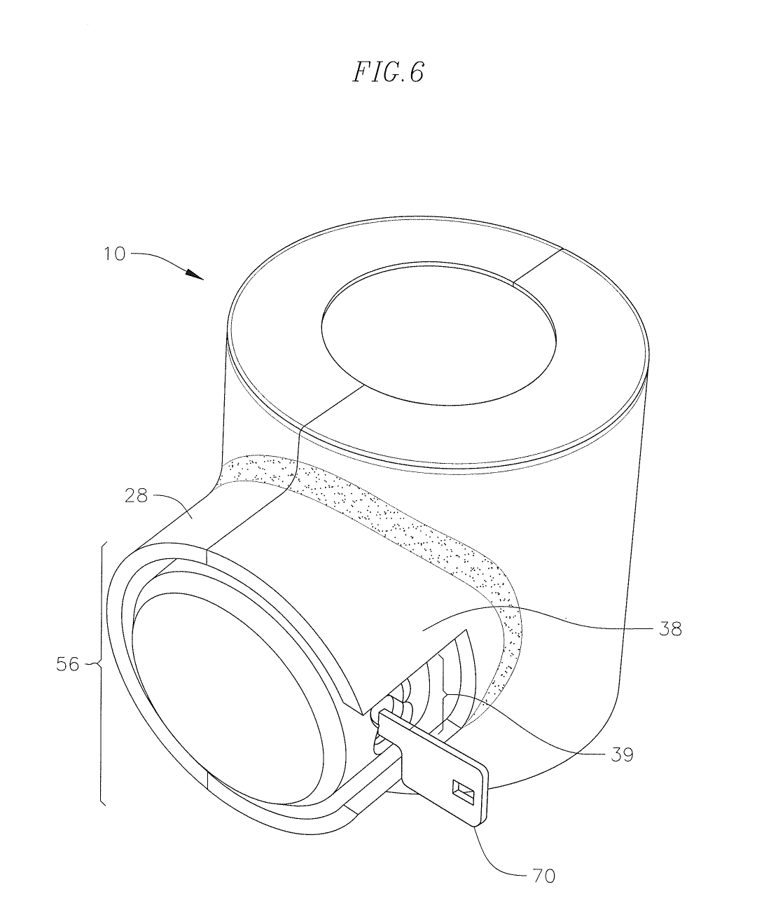

As shown in FIG. 3, the housing 10 is designed to work with a “shackleless” lock, also called a “hidden shackle” or “hockey puck” lock, one embodiment of which is shown in FIGS. 4 and 5. The lock 60 includes a hardened steel body 62 having a slot 64 and a hole 65 formed therein. A cylinder 66 (e.g., a 5- or 6-pin cylinder) is coupled to a bolt or shackle 67, the distal tip 68 of which can engage two hardened steel retaining pins 69 located in the hole 65 in the lock. In the embodiment shown, the lock is stepped, and a portion of the back face is elevated relative to the remainder of the back face. This configuration is preferred because it helps bring the backside of the lock closer to the curved side walls of the first and second enclosure portions of the housing of the lockable housing. Shackleless locks having other configurations and features can be employed in the alternative.

In FIG. 3, the lock cylinder 66 is retracted and the lock 60 is shown ready to be inserted in the space 57 defined by the shroud 56 and a portion of the curved side walls 21, 31 of the first and second enclosure portions 20, 30 of the housing. The lock is ready to engage the “hasp” formed by the first and second enclosure portions, tabs, and shroud.

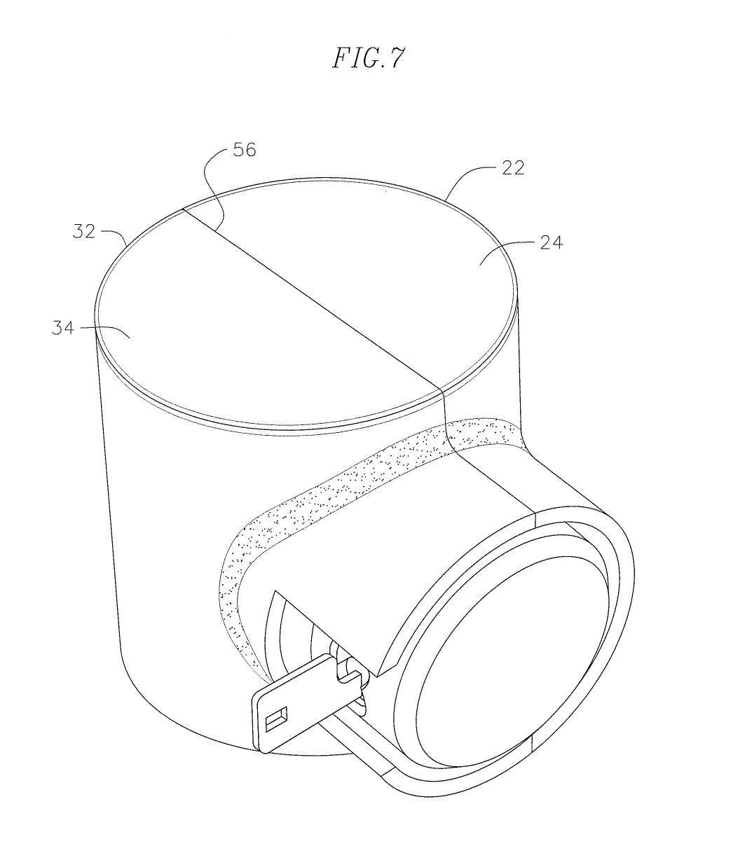

In FIG. 6, the lock is seated in place and protected by the shroud 56. The tabs 26, 36 fit within the slot 64 in the lock, and the bolt or shackle 67 can engage the holes 27, 37 in the tabs. The key 70 extends through the gap 39 in the second flange 38. Notably, with the lock in place, even if the hinge is destroyed the housing will remain intact and in place.

FIG. 7 shows a distal or bottom view of the closed housing. The end walls 22, 32 of the first and second enclosure portions meet at a seam 56. However, the inner cavity of the housing cannot be accessed through the seam because the lip 41 extending from the inner surface 33 of the second end wall 32 overlaps part of the first end wall 22 of the first enclosure portion.

In this embodiment, the housing is made of steel (for example, 4 inch diameter, schedule 40 pipe) or another suitably hard material. The tabs and flanges are welded to the first and second enclosure portions, and the lip is welded to the end wall of the second enclosure portion. (Welds are denoted by dotted regions in the drawings.) Other materials and modes of construction are also possible. The dimensions of the lockable housing reflect the length, shape, and diameter or outer perimeter of the fixture(s) to be protected. In the embodiment depicted in the drawings, the housing 10 is approximately 5.5 inches tall and has an outer diameter of about 5.25 inches. The shroud has an outer diameter of about 4 inches, protrudes approximately 2 inches from the side of the housing, and can hold a 3 inch diameter shackleless lock. The drawings are not necessarily to scale.

The invention has been described with reference to various drawings and embodiments, but is not limited thereto. Other embodiments and variations will be apparent to the skilled person, without departing from the invention. For example, the housing 10 may have a shape other than cylindrical; the collar need not be annular, but may have an alternate shape; etc. The invention is limited only by the appended claims and equivalents thereof.

What is claimed is:

1. A lockable housing for a fixture, comprising:
a first enclosure portion, bounded at one end by a first end wall and bounded at an opposite end by a first collar portion;
a first tab and a first flange portion extending from the first enclosure portion;
a second enclosure portion, bounded at one end by a second end wall and bounded at an opposite end by a second collar portion;
a second tab and a second flange portion extending from the second enclosure portion; and
a hinged joint linking the first enclosure portion to the second enclosure portion;
wherein, when the first enclosure portion and the second enclosure portion are brought together in a closed configuration, (a) the first and second end walls are brought together, (b) the first and second enclosure portions form a cavity large enough to encase the fixture, (c) the first and second tabs are brought together, (d) the first and second flange portions are brought together and form a protective shroud adapted to house a shackleless lock that can engage the first and second tabs, and (e) the first and second collar portions form a collar.

2. The lockable housing as recited in claim 1, wherein the first and second enclosure portions are substantially semicylindrical.

3. The lockable housing as recited in claim 1, wherein the first flange portion is oriented substantially 90 degrees to the first enclosure portion.

4. The lockable housing as recited in claim 1, wherein the second flange portion is oriented substantially 90 degrees to the second enclosure portion.

5. The lockable housing as recited in claim 1, wherein the first and second flange portions are semicircular.

6. The lockable housing as recited in claim 1, wherein at least one of the first and second flange portions has a gap through which a key can be passed.

7. The lockable housing as recited in claim 1, wherein the collar is annular.

8. The lockable housing as recited in claim 1, further comprising a lip extending from the first or the second end wall.

9. The lockable housing as recited in claim 1, further comprising a shackleless lock seated within the protective shroud.

10. A lockable housing for a fixture, comprising:
a substantially semicylindrical first enclosure portion, bounded at one end by a first end wall and at an opposite end by a first collar portion;
a first tab and a semicircular first flange portion extending from the first enclosure portion, the first tab located in or adjacent to a semicircular space defined by the first flange portion;
a substantially semicylindrical second enclosure portion, bounded at one end by a second end wall and at an opposite end by a second collar portion;
a second tab and a semicircular second flange portion extending from the second enclosure portion, the second tab located in or adjacent to a semicircular space defined by the second flange portion; and
a hinged joint linking the first enclosure portion to the second enclosure portion;
wherein, when the first and second enclosure portions are brought together in a closed configuration, (a) the first and second end walls are brought together, (b) the first and second enclosure portions form a cavity large enough to encase the fixture, (c) the first and second tabs are brought together, (d) the semicircular first and second flange portions are brought together and form a protective shroud adapted to house a shackleless lock that can engage the first and second tabs, and (e) the first and second collar portions are brought together and form a collar.

11. The lockable housing as recited in claim 10, wherein the collar is annular.

12. The lockable housing recited in claim 10, further comprising a lip extending from the first or second end wall.

13. A lockable housing for a fixture, comprising:
a hinged, clam-shell enclosure, adapted to be moved from an open to a closed configuration;
a collar at one end of the enclosure;
a wall an at opposite end of the enclosure; and
a hasp secured to or integral with the enclosure, adapted to hold a shackleless lock;
wherein, the enclosure can be placed around a fixture and then closed; a shackleless lock can be secured to the hasp and locked in place, thereby holding the enclosure in the closed configuration; and the collar is adapted to prevent the enclosure from being removed from the fixture while the enclosure is in the closed configuration.

14. The lockable housing as recited in claim 13, wherein the clam-shell enclosure has a substantially cylindrical shape when in the closed configuration.

15. The lockable housing as recited in claim 13, wherein the collar has a substantially annular shape when the enclosure is in the closed configuration.
